(19) United States
(12) Patent Application Publication
(10) Pub. No.: US 2026/0100197 A1
(43) Pub. Date: Apr. 9, 2026

(54) SECURE MEDIA SCANNER

(71) Applicant: Data Security, Inc., Lincoln, NE (US)

(72) Inventors: Jesse Doyle, Lincoln, NE (US); Walker Arce, Omaha, NE (US)

(21) Appl. No.: 19/352,188

(22) Filed: Oct. 7, 2025

Related U.S. Application Data
(60) Provisional application No. 63/704,948, filed on Oct. 8, 2024.

(51) Int. Cl. G11B 5/465; B02C 18/00; G06K 7/14

(52) U.S. Cl. CPC G11B 5/465; B02C 18/00; G06K 7/1408

(57) ABSTRACT

A scanning device is configured to receive an information storage medium in a secured facility, scan the information storage medium, and automatically generate a transfer storage medium embedding machine-readable code with information sufficient to identify the information storage medium and/or a status of the information storage medium via reading the transfer storage medium.

### CROSS-REFERENCE TO RELATED APPLICATION

This application claims the benefit of U.S. Provisional Application No. 63/704,948 filed Oct. 8, 2024, which is incorporated herein by reference in its entirety.

### TECHNICAL FIELD

This invention relates generally to media scanners and in particular to scanners for use in secure facilities.

### BACKGROUND

When a government entity decommissions information storage media with classified information, the process must occur within a Sensitive Compartmentalized Information Facility (SCIF). SCIFs operate under strict control regulations including rules that restrict the ingress and egress of non-volatile information storage media, such as flash drives. In many cases, the process of decommissioning information storage media requires a feedback process, where the serialization information that uniquely identifies a given physical storage device must be reported back to the entity with original custody. Because this serialization information itself is not classified (while the information stored on that device is classified), the serialization information can be written down on paper for movement out of the SCIF, but this information still cannot be transmitted through digital means. In practice, people write down the information regarding storage media on paper, which information is unclassified and thus the paper can be carried outside the SCIF to report the handling of the restricted physical storage device.

Current technology for serialization information scanning devices are limited to handheld scanning devices and rare instances of camera-based scanning devices that ‘auto-scan’ the media for its barcode information. In the cases of the entire facility being a SCIF, this approach works well enough to facilitate their functionality because the collected information never leaves the SCIF, but in the case where the SCIF is mobile or a segmented portion of a larger facility, the information generated by the serialization scanning device cannot be exfiltrated from the SCIF without violating federal law unless it is written down on paper. Unfortunately, the end result of these regulations is that approaches that embody using RFID tags placed on magnetic media devices or transmission of the serialization information via non-volatile information storage media cannot be used because such devices would not be authorized to leave the SCIF.

Existing commercial equipment may involve the use of a large touchscreen for secondary credential input, it has an included handheld scanner (indicating that it cannot reliably read barcodes via the embedded camera sensor), and it provides no means for the equipment to be operated within a SCIF.

When developing technology to scan information such as barcodes on storage media, such as hard disk drives or solid state drives, there are a number of other challenges. First, there is no homogeneity in the physical appearance of each piece of media. For instance, the height of different models of hard disk drive will vary by small amounts, the coloration and emissivity of the enclosure material will vary, and the level of wear on the label will vary. Second, many of the organizations performing decommissioning of recording media are government facilities with varied security requirements. Third, maintaining the chain of custody for the decommissioned recording media is difficult in the current environment, requiring large touchscreens and the memorization of secondary credentials, increasing the level of cognitive load required to interact with existing equipment.

### BRIEF DESCRIPTION OF THE DRAWINGS

The above needs are at least partially met through provision of the secure media scanner described in the following detailed description, particularly when studied in conjunction with the drawings, wherein:

FIG. 1 comprises a perspective view of a scanner device as configured in accordance with various embodiments of the invention;

FIG. 2 comprises a schematic diagram of a complimentary system as configured in accordance with various embodiments of the invention;

FIG. 3 comprises a flow diagram of a process as configured in accordance with various embodiments of the invention;

FIG. 4 comprises a flow diagram of a process as configured in accordance with various embodiments of the invention;

FIG. 5 comprises a left side upper perspective view of an internal portion of a scanner device as configured in accordance with various embodiments of the invention;

FIG. 6 comprises a left rear upper perspective view of an internal portion of the scanner device of FIG. 5;

FIG. 7 comprises a right rear upper perspective view of an internal portion of the scanner device of FIG. 5;

FIG. 8 comprises a left upper perspective view of a further internal portion of the scanner device of FIG. 5;

FIG. 9 comprises a left front upper perspective view of the internal portion of the scanner device of FIG. 8;

FIG. 10 comprises a left upper perspective view of a further internal portion of the scanner device of FIG. 5 in a different configuration;

FIG. 11 comprises a left side upper perspective view of an internal portion of a scanner device with a degausser device as configured in accordance with various embodiments of the invention;

FIG. 12 comprises a left side view of an internal portion of the scanner device with the degausser device of FIG. 11;

FIG. 13 comprises a top view of an internal portion of the scanner device with the degausser device of FIG. 11;

FIGS. 14A and 14B comprise a flow diagram of a process as configured in accordance with various embodiments of the invention; and

FIG. 15 comprises a schematic diagram of a system in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a media serialization scanning device is configured to scan information storage media and incorporates a transfer device that stores or embeds information from the information storage media on a transfer storage medium for secure transport out of a secure facility such as an SCIF. In some examples, the transfer device is a printer and the transfer storage medium is a printed material such as a piece of paper that embeds information scanned from the information storage device. Information collected from the information storage media may be incorporated into a paper print out such as in a bar code or QR code that can be removed from a secure facility. In some examples, the transfer device is a media drive such as a DVD drive or a flash media port (e.g., USB) that embeds information scanned from the information storage device on a digital storage medium. Information collected from the information storage media may be incorporated onto the DVD, flash drive, or the media device that can be removed from a secure facility. The transfer storage media (e.g., paper print out, DVD, CD-ROM, SD card, solid state drive or hard disk drive, etc.) is unclassified and can be transferred out of the secured facility and read at another facility such that media tracking across facilities can be reliably accomplished.

These and other benefits may become clearer upon making a thorough review and study of the following detailed description. Referring now to the drawings, an illustrative device that is compatible with many of these teachings will now be presented.

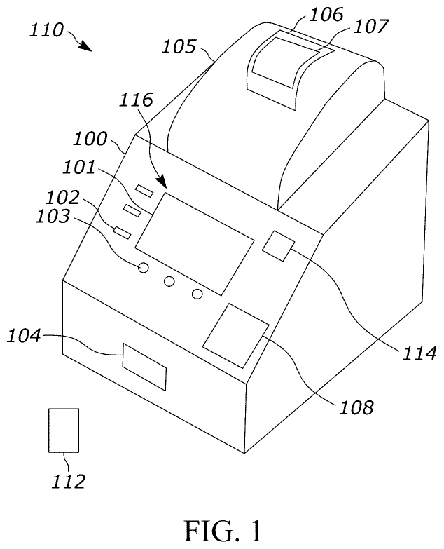

FIG. 1 illustrates an example apparatus 110 for processing secure media at a secured facility, according to some embodiments. The apparatus 110 may be used to acquire information from one or more information storage media 112 and print machine-readable code embedding such information. In some embodiments, the apparatus 110 is to track serialization information that is used to track the custody and/or decommissioning of the information storage medium 112. The apparatus 110 may be used in conjunction with a decommissioning device that is used to decommission the information storage medium 112, such as a degausser or other device that is operable to sanitize or remove data from the information storage medium 112. In some aspects, the apparatus 110 can be used in a secure environment such as a Sensitive Compartmented Information Facility (SCIF).

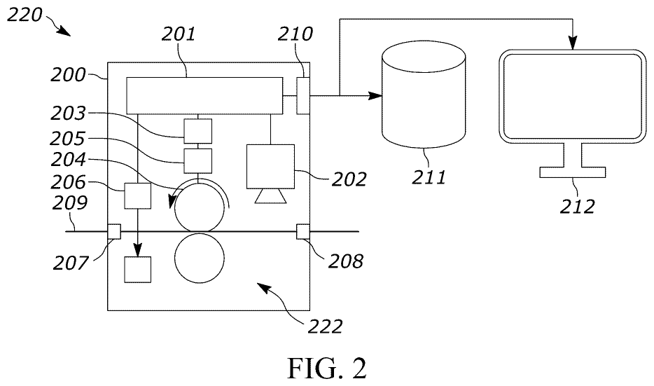

The apparatus 110 incorporates a transfer device 105 which, in the illustrated embodiment, is a printer that may be used for printing machine-readable code embedding information, such as serialization information, from the information storage medium 112. The transfer device 105 will be referred to herein as the printer 105. Serialization information may include unique identifiers such as barcodes, serial numbers, etc. associated with the information storage medium 112. In some examples, the printer 105 is a thermal transfer paper printer, colloquially known as a receipt printer. The printer 105 may print a paper 106 including the machine-readable code. In some embodiments, the machine-readable code is a dense 2D barcode, such as a QR code or DataMatrix code, that aggregates media serialization information into a single symbol. As discussed further below, in some embodiments, the media serialization information may be scanned and decoded by other equipment for downstream processing (see FIG. 2).

In some implementations, the transfer device 105 is a printer that is configured to operate with different printing mediums, such as radio frequency identification (RFID), near filed communication (NFC), or other radio communication storage devices that can aggregate relatively large amounts of information for a long period of time. In some aspects, the inclusion of anti-tampering and physically unclonable functions may make it so that the information generated by the apparatus 110 and on the radio tag cannot be overwritten.

In some implementations, the transfer device 105 may further or alternatively include media drive, such as a DVD drive, flash drive, or ethernet port, to facilitate the transfer of information from the information storage medium 112 to another type of transfer storage medium (e.g., DVD, CD-ROM, SD card, solid state drive or hard disk drive, etc.).

The apparatus 110 includes a housing 100 with a user interface 116 to present content to a user and/or receive input via one or more modalities. The user interface 116 includes a display 101, one or more indicator lights, and/or one or more buttons 103 for operator control. The housing 100 also defines a scanning device interface 104, such as a USB interface, for coupling the apparatus to a scanning device. In some aspects, the scanning device is a handheld barcode scanner.

The apparatus 110 includes a card scanner 108 configured to obtain user identification information from a card associated with a user. The card scanner 108 may be a smart card reader that is operable to read a Common Access Card (CAC) or another smart card that identifies the user. Generally speaking, government employees possess a smart card that uniquely identifies the individual or user. Many private industry employees also have smart cards, which are ISO/IEC 7816 compliant and compatible with the apparatus 110. In some configurations, the card scanner 108 includes an insert slot configured to receive a CAC or other smart card. In some embodiments, inserting a card into the card scanner 108 initiates a use session and enables operation of the apparatus 110. When the card is removed from the apparatus 110, the apparatus 110 may lock out the user and engage the printing process to export the barcodes reflecting the information storage media 112 scanned during the use session. In other embodiments, a user may manually initiate a use session and/or select when the printing process occurs. Such a manual process may provide practical operation over longer durations where breaks in usage and/or shift changes occur during a media decommissioning event.

The apparatus 110 is operatively connected to a local processing device 114. The local processing device 114 may be part of the apparatus 110, as illustrated, or separate from the apparatus 110. The local processing device 114 is operatively connected to the transfer device 105, the user interface 116, and the scanning device interface 104.

In operation, a user may use a scanning device, such as a handheld barcode scanner, to record the serialization information from the information storage media 112. The local processing device 114 aggregates the serialization information internally. The local processing device 114 then generates machine-readable code, such as a dense 2D barcode, that contains the aggregated serialization information. The local processing device 114 then may cause the transfer device 105 (e.g., a printer) to print the machine-readable code. The printing process can be either prompted by the user when their process is complete or automatically triggered when the maximum number of characters are reached that can be contained within the machine-readable code (e.g., the dense 2D barcode). Finally, during or after a scanning operation, the apparatus 110 can print machine-readable code embedding information including process parameters and device state associated with the decommissioning event on a material such as a paper. For example, the apparatus 110 may embed a status of the information storage medium 112 such as a degaussing and/or physical destruction status of the information storage medium 112 in the machine readable-code. In some examples, the apparatus 110 may cause the transfer device 105 to embed a status of the information storage medium 112 including one or more of an amount of time the information storage medium 112 was exposed to a degaussing magnetic field, a degaussing magnetic field strength applied to the information storage medium 112, a date and/or time at which the information storage medium 112 was degaussed and/or physically destroyed, an indication of whether the information storage medium 112 was degaussed and/or physically destroyed, or combinations thereof.

The user may then then take the material (e.g., a printed paper) with the machine-readable code generated during the decommissioning event and exit the secure facility (e.g., the SCIF). Outside of the secure facility, a complementary device, such as a reader 220 as shown in FIG. 2, can read the material with the machine-readable code (e.g., the printed paper).

Turning to FIG. 2, the reader 220 that can be used to read a printed material 209 with machine-readable code printed thereon generated via the apparatus 110 is shown. For example, the reader 220 can be used to read media serialization information embedded in the machine-readable code. In one embodiment, the printed material 209 is a piece of paper with a dense barcode printed thereon. The reader 220 includes a reader housing 200 that defines an entry port 207 for receiving the printed material 209 and an exit port 208 for releasing the printed material 209. The reader housing 200 includes a reader compartment 222 for receiving the printed material 209. The reader compartment 222 includes a reader scanning device 202 and a feeding mechanism 204 for moving the printed material 209 across the reader scanning device 202 to scan the printed material 209. The reader scanning device 202 may be selected from the group comprising a camera, a 1D scanner, a 2D image sensor, a barcode scanner, and combinations thereof. The feeding mechanism 204 may be driven by one or more actuators. In some embodiments, the feeding mechanism 204 includes a pair of rollers driven by roller actuators (e.g., motors). The actuator of the feeding mechanism 204 may be coupled to a motor driver 205 that controls the speed, torque, and position of the actuator and a current sensor for monitoring the actuator current. Though, any suitable feeding mechanism 204 can be used, depending on the type of printed material 209. The reader compartment 222 also includes a laser gate 206 to detect when the printed material 209 has entered the reader compartment 222.

The reader 220 includes a reader controller 201. The reader controller 201 is operatively connected to the reader scanning device 202, the feeding mechanism 204, and the laser gate 206. The reader controller 201 may also be coupled to the motor driver 205 and the current sensor 203. As illustrated, the reader controller 201 is local processing device and is incorporated into the reader 220. In some embodiments, the housing 200 defines a media port 210, such as a USB port, for interfacing with one or more external processing systems. The reader 220 can interface with one or more external databases 211 and/or one or more external computers 212 via the media port 210 to store information embedded in the machine-readable code. For example, the reader 220 may store media serialization information embedded in the machine-readable code in an external database 211 and/or an external computer 212.

In operation, the feeding mechanism 204 is triggered using the laser gate 206 to detect the entrance of the printed material 209 within the entry port 207. The feeding mechanism 204 brings the printed material 209 within the reader compartment 222. The feeding mechanism 204 moves the printed material 209 across the reader scanning device 202 to scan the printed material 209 to read the machine-readable code printed thereon to retrieve the serialization information and stores the serialization information internally. As the printed material 209 is processed, it exits the reader 220. The exit port 208 of the reader 220 releases the printed material 209 back to the user for appropriate destruction. The reader 220 connects serially to an external computer 212 that is running a software program that receives the aggregated serialization information. This software program can either generate a report file that is independent of their existing recording processes or automatically fill out an existing process report. In either case, the aggregated serialization information may be stored in a digital representation on the external computer 212 and/or on the external database 211 for use. Finally, this reader 220 may also receive the process parameters and the media serialization scanning device state from machine-readable code on the printed material 209, which can then prompt the operator to seek service from the original manufacturer in the case of issues being present.

The reader 220 feeds the printed material 209 into itself using the feeding mechanism 204 with coupled actuators. As illustrated, the feeding mechanism 204 includes rollers that grip the printed material 209 and pull it deeper into the reader compartment 222 to present it to the reader scanning device 202, which is coupled to the reader controller 201, allowing the scanning of the machine-readable code on the printed material 209 to retrieve the aggregated media serialization information. The motor driver 205 provides the voltage and/or current of the feeding mechanism 204 to generate the requisite torque to pull the printed material 209 through the reader compartment 222. The current sensor 203 is coupled to the motor driver 205, allowing the reader controller 201 to detect system jams through an increase in current.

In some embodiments, the roller actuators are differentially driven to limit or prevent jamming. Differentially driven roller actuators may help to ensure that the angle of travel for the media (e.g., paper) passing through the rollers does not cause the media to mate with sides of the reader compartment 222, which may result in a jam.

Those skilled in the art will recognize and understand that the reader 220 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

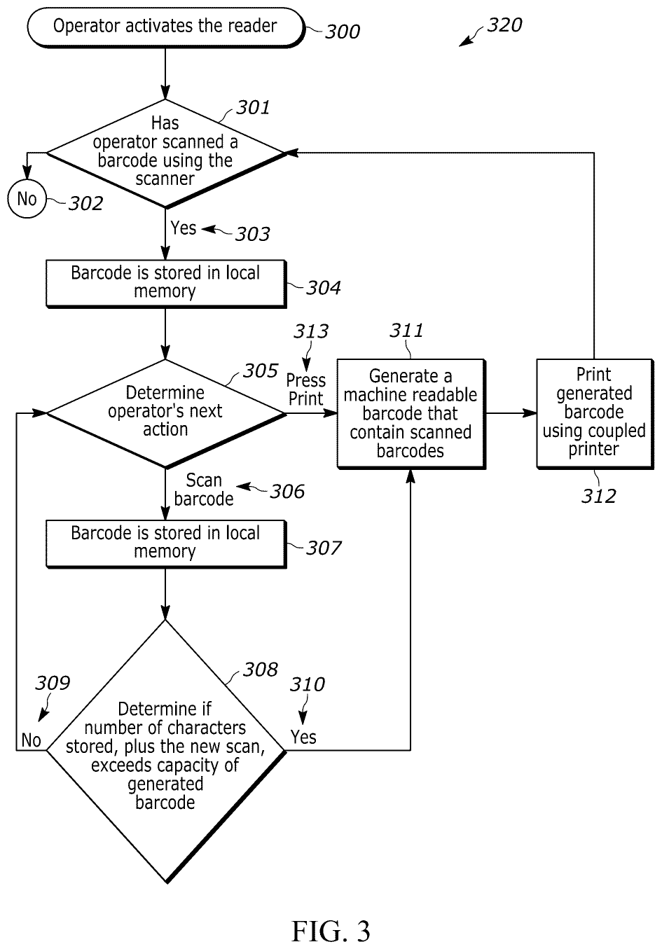

FIG. 3 illustrates a process 320 for operating the apparatus 110 of FIG. 1 according to various embodiments. In the process 320, the apparatus 110 is used to scan one or more information storage media 112 to read barcodes thereon to obtain serialization information and to generate a printed material 209 with machine-readable code embedding the serialization information. In some implementations, the process 320 or portions thereof is implemented via the local processing device 114. That is, the local processing device 114 may be configured to perform the process 320 or portions thereof.

At 300, a user or operator activates the apparatus 110. The local processing device 114 determines whether the operator has a barcode (or other machine-readable code) on the information storage medium 112. The local processing device 114 determines whether the operator has scanned a barcode using the scanning device that is coupled to the apparatus 110 via the scanning device interface 104. At 302, the local processing device 114 waits for an operator to scan the barcode. At 303, the local processing device 114 determines that an operator has scanned a first barcode. Upon determining that the first barcode has been scanned, the local processing device 114 stores the first barcode for later printing. At 305, the local processing device 114 waits for the operator to perform another action using the apparatus 110 (e.g., to scan another barcode). At 306, the local processing device 114 determines that a second barcode has been scanned and, at 307, the second barcode is stored in local memory for later printing.

At 308, the local processing device 114 checks character limit of the aggregated barcodes, including the first and second barcodes. The local processing device 114 may determine whether if a number of characters stored for the first scan (the first barcode) and the second scan (the second barcode) exceeds a capacity of a generated machine-readable code (e.g., a dense barcode) to be generated by the apparatus 110. At 309, the local processing device 114 determines that the capacity has not been exceeded and proceeds, at 304, to receive additional scans of barcodes. At 310, the local processing device 114 determines that the capacity has been exceeded and proceeds, at 311, to aggregate the first and second barcodes to generate a machine-readable code, such as a dense barcode, that aggregates all scanned barcodes, namely, the first and second barcodes. At 312, the local processing device 114 prints the resulting machine-readable code using the transfer device 105. At 313, the operator requests the currently scanned barcodes to be aggregated and printed via the transfer device 105.

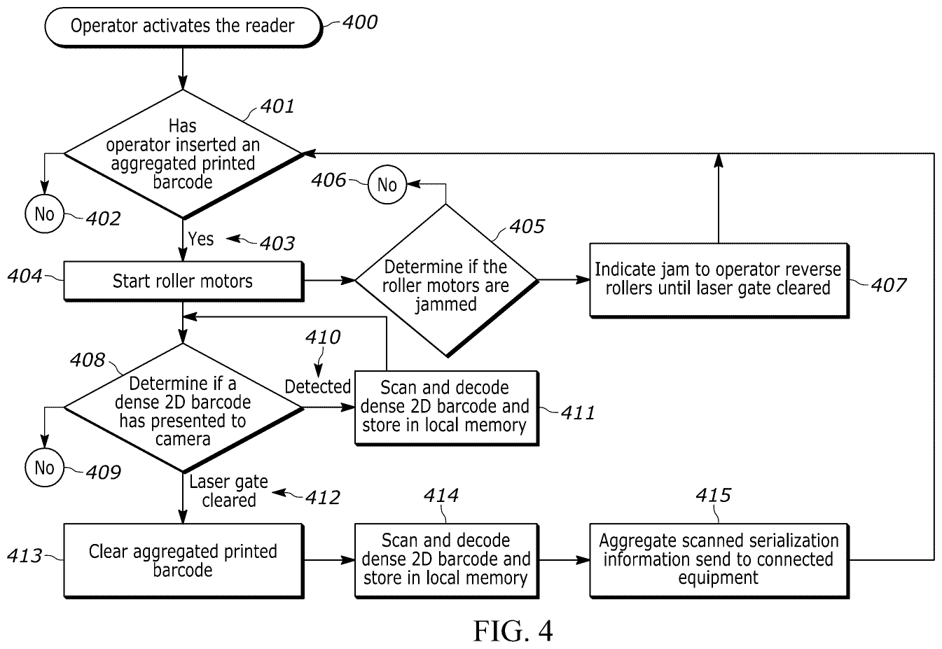

FIG. 4 illustrates a process 420 for operating the reader 220 of FIG. 2 according to various embodiments. In the process 420, the reader 220 is used to read the machine-readable code from the printed material 209 to acquire serialization information embedded in the machine-readable code.

At 400, an operator activates the reader 220 and the reader controller 201 detects entry into the reader 220. At 404, the reader controller 201 determines if the operator has inserted a printed material 209, such as a paper with machine-readable code (e.g., an aggerated printed barcode), into the reader 220. At 402, the reader controller 201 monitors the laser gate 206 and waits until a printed material 209 is detected. At 403, the reader controller 201 determines that a printed material 209 has been detected via the laser gates 206. At 404, the reader controller 201 powers the actuators of the feeding mechanism 204. The reader controller 201 determines, at 405, if the actuators coupled to the feeding mechanism 204 have jammed by monitoring the current sensor 203. At 406, the reader controller 201 waits for the current sensor 203 to signal that the actuator current has risen above a threshold value. Upon determining that the actuator current has exceeded the threshold value, at 407, the reader controller 201 provides an indication that the reader 220 has jammed and/or reverses the printed material 209 out of the reader 220 by reversing the feeding mechanism 204.

At 408, the reader controller 201 determines if machine-readable code (e.g., a dense barcode) on the printed material 209 has been presented to the reader scanning device 202. At 409, the reader controller 201 waits until the machine-readable code is presented. At 410, the reader controller 201 determines, via the reader scanning device 202, that the machine-readable code has been presented. At 211, the reader controller 201 scans the printed material 209 via the reader scanning device 202 and decodes the machine-readable code (e.g., the dense barcode) and stores the encoded information in local memory.

At 412, the reader controller 201 receives an indication that the laser gate 206 has been cleared and the end of the printed material 209 has been reached. At 413, the reader controller 201 continues to engage the actuators of the feeding mechanism 204 for a sufficient duration to clear the printed material 209 from the reader 220. At 414, if a machine-readable code is presented while clearing the printed material 209, the reader controller 201 scans the machine-readable code via the reader scanning device 202, decodes the machine-readable code, and stores the machine-readable code in local memory. At 415, the reader controller 201 aggregates the information from the machine-readable code (e.g., the serialization information) in local memory and may send such information to equipment connected to the reader 220, such as, to the external database 211 and/or the external computer 212.

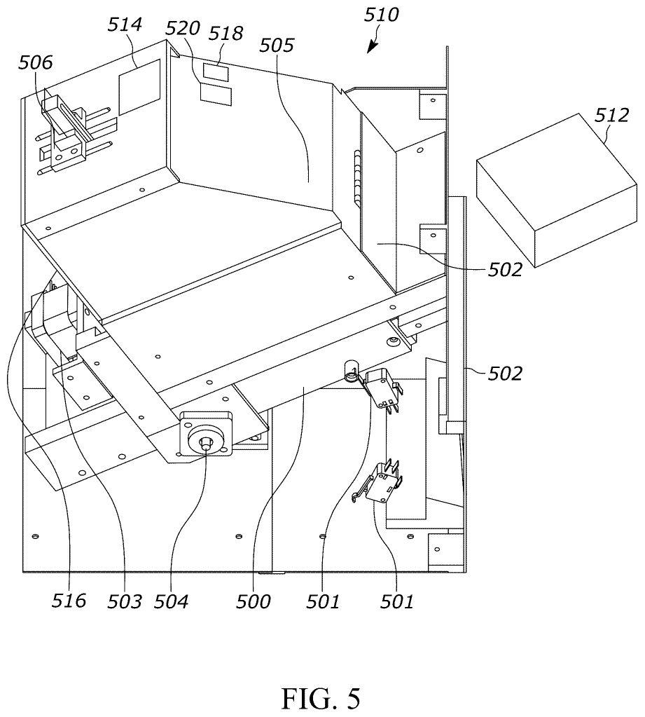

FIGS. 5-10 illustrates an apparatus 510 that may be used for processing secure media at a secured facility, according to some embodiments. The apparatus 510 is an automatic scanner and may be referred to herein as an “auto scanner.” The apparatus 510 may be used to acquire information from one or more information storage media 512, save the information in local memory, and export the information to a transfer storage medium, such as a printer or DVD. In some embodiments, the apparatus 510 is used to track serialization information that tracks the custody and/or decommissioning of the information storage medium 512.

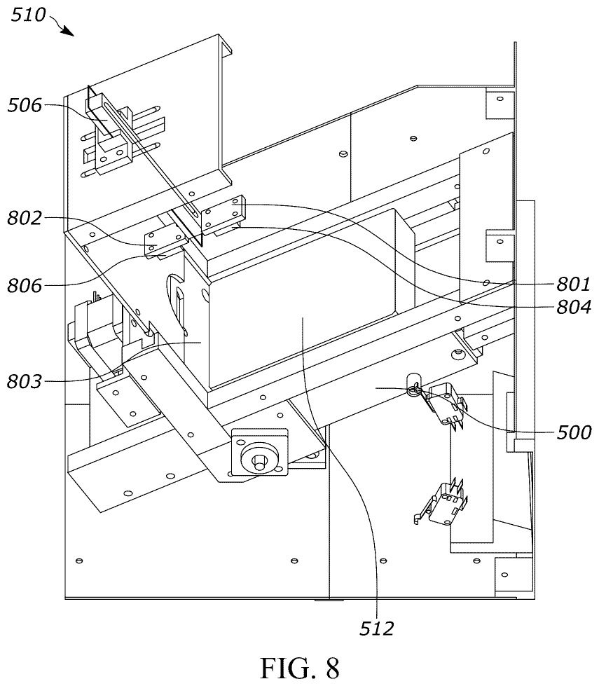

The apparatus 510 includes scanning device 804 (FIGS. 8-10) disposed and configured to capture device information from the information storage medium 512. In some aspects, the apparatus 510 further includes a distance sensor 806 (FIGS. 8-10) configured to detect the information storage medium 512 in the compartment 706 and/or to provide data useful for focusing the scanning device 804 (FIGS. 8-10). The scanning device 804 and the distance sensor 806 are operatively connected to a processing device 514.

The processing device 514 may be configured to export or transfer device information captured from the information storage medium 512 to a transfer storage medium. In some implementations, the transfer storage medium is a information storage medium such as a DVD, a CD-ROM, an SD card, a solid state drive, or a hard disk drive. In such an implementation, the apparatus 510 includes a media drive 518 as a transfer device for inserting the information storage medium such that the information can be exported to the information storage medium. In some implementations, the transfer storage medium is a piece of paper to embed the information in machine-readable code on the material. In such an implementation, the apparatus 510 includes a printer as a transfer device to print the machine-readable code embedding the information acquired by the apparatus 510.

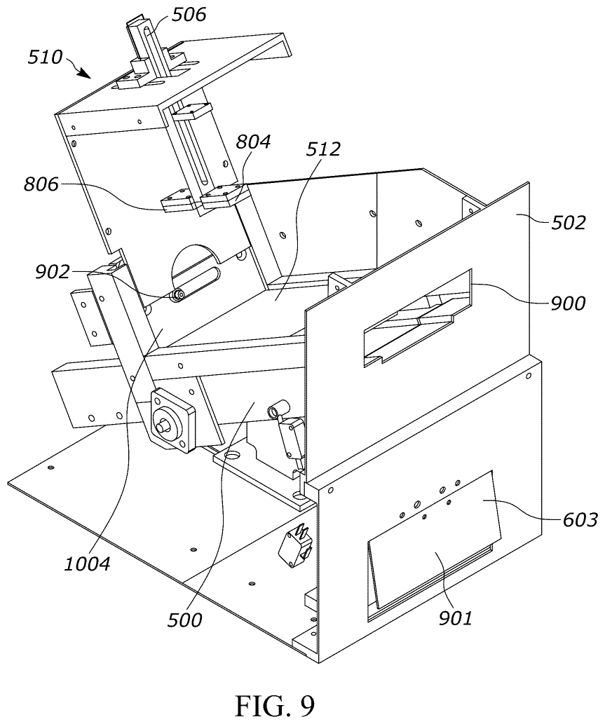

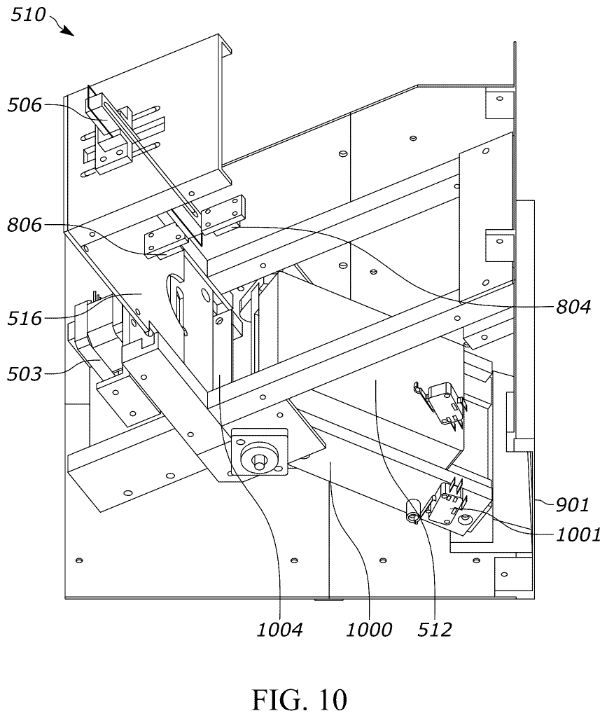

Turning to FIG. 5, the apparatus 510 has housing 505 that defines a compartment 500 to receive the information storage medium 512. The compartment 500 may be a media tray or any other receptacle that is configured to hold the information storage media 512. The shape and configuration of the compartment 500 may depend on the size and/or shape of the information storage medium 512 intended to be processed with the apparatus 510. The housing 505 has a front panel 502 defining a device receiving aperture 900 (FIG. 9) for receiving the information storage medium 512 and a media reject opening 901 (FIG. 9) for releasing the information storage medium 512 from the compartment 500 for rejection. The housing 505 has a rear panel 516 defining a media accept opening 1004 (FIG. 10) for releasing the information storage medium 512 from the compartment 500 for acceptance. The compartment 500 may receive the information storage medium 512 from the device receiving aperture 900 (FIG. 9) and may reject or release the information storage medium 512 from the media reject opening 901 (FIG. 9) or the media accept opening 1004 (FIG. 10).

The compartment 500 is coupled to a compartment shaft 504 and is able to pivot about the shaft 504 to reposition or reorient. The compartment 500 may be movable between a first position (FIGS. 5-9) in which the compartment 500 is raised and a second position (FIG. 10) in which the compartment 500 is lowered. In some embodiments, the compartment 500 may be further movable into a third position that passes the information storage medium 512 into one or more downstream devices for further processing. The downstream devices may include magnetic degaussers, device shredders, or other erasure or destruction devices for the information storage medium 512. The apparatus 510 may include one or more limit switches 1001 to indicate the position of the compartment 500 to the processing device 514.

In the first position (FIGS. 5-9), the compartment 500 may receive the information storage medium 112 that passes through the device receiving aperture 900 (FIG. 9). In the first position, the compartment 500 is aligned with the device receiving aperture 900 (FIG. 9) and the media accept opening 1004 (FIG. 10) to allow the information storage medium 512 to translate from the device receiving aperture towards the device accept opening 1004 (FIG. 10).

In the second position, the compartment 500 may move the information storage medium 512 out of the apparatus 510 via the media reject opening 901. In the second position, the compartment 500 is aligned with the media reject opening 901 to allow the information storage medium 512 to translate towards the media reject opening 901.

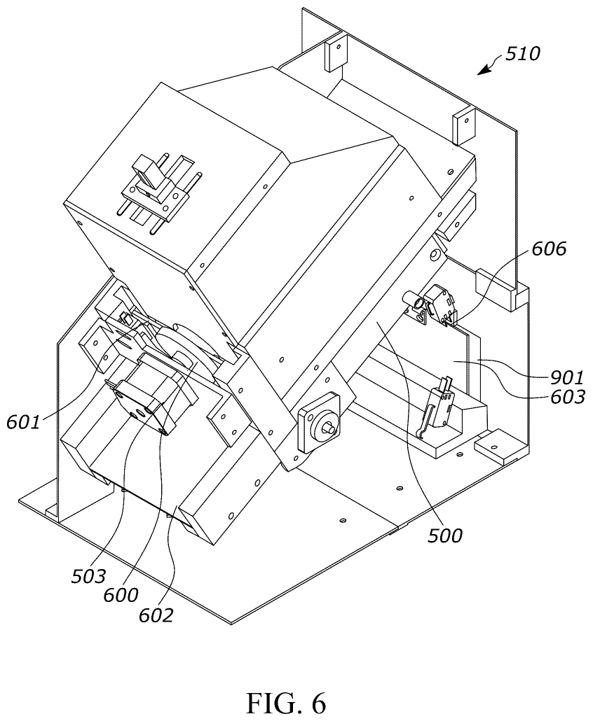

Referring to FIG. 6, the apparatus 510 has a media accept door 601 to selectively block the media accept opening 1004 (FIG. 10). The media accept door 601 may block or prevent the entrance of the information storage medium 512 into downstream equipment. A wheel 600 (or other rotating mechanism) is coupled to the media accept door 610 that, when actuated, causes the media accept door 610 to actuate the media accept opening 1004 (FIG. 10), allowing any media staged within the compartment 500 to translate through the media accept opening 1004 (FIG. 10) past the media accept door 601 into any downstream equipment. As illustrated, the media accept door 601 is configured to actuate or translate vertically to clear the media accept opening 1004 (FIG. 10), however, in other configurations, the media accept door 601 may be configured to translate horizontally or to rotate or pivot.

As shown in FIG. 6, the apparatus 510 includes a first stepper motor 503 (see also FIG. 5) to actuate the media accept door 601. The first stepper motor 503 is coupled to the wheel 600, which slots into the media accept door 601. In some embodiments, the first stepper motor 503 rotates to cause a side-to-side actuation that causes the media accept door 601 to raise or lower depending on the position of the wheel 600.

In FIG. 6, the media reject opening 901 is shown blocked by a media reject door 603. As illustrated, the media reject door 603 has a top face 606 that is angled towards the interior of the apparatus 501 to bias the media reject door 603 towards the closed position. Such angling of the top face 606 helps to provide a passive closing of the media reject door 603. In some configurations, the media reject door 603 is slightly recessed into the apparatus 510 to prevent or limit external opening of the media reject door 603.

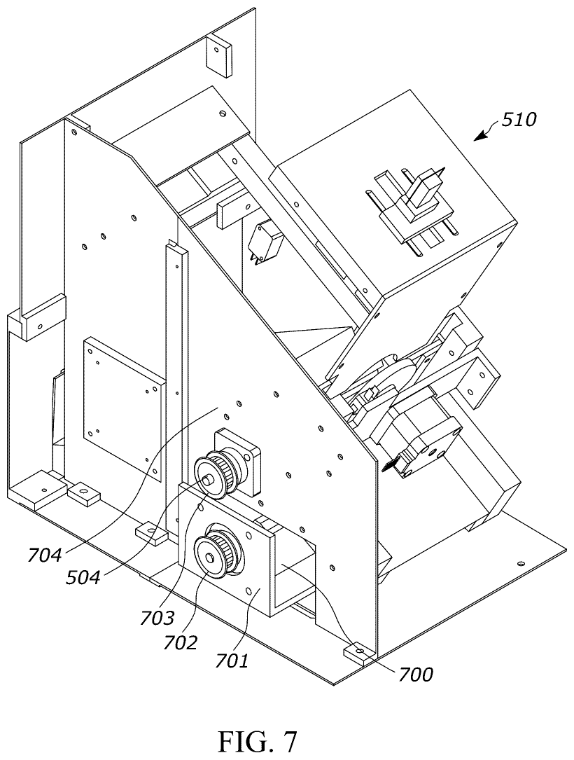

Referring to FIG. 7, the apparatus 510 further includes a second stepper motor 700 that engages the compartment shaft 504 to rotate the compartment shaft 504 and accordingly move the compartment 500. For example, operating the second stepper motor 700 may move the compartment 500 between the first position and the second position, or to any other intermediate positions therebetween. The second stepper motor 700 is mounted to a side panel 704 of the apparatus 510 via a motor bracket 701. Mechanical mechanisms and electrical components associated with the second stepper motor 700 can be mounted to the side panel 704. The second stepper motor 700 includes motor gearing that engages with shaft gearing 703 on the compartment shaft 504 to rotate the compartment shaft 504.

The second stepper motor 700 is coupled to the compartment shaft 504 that has the compartment 500 coupled thereto such that the rotation of the second stepper motor 700 causes corresponding rotation in the compartment 500. When the compartment 500 is rotated to the first or upright position, the stall torque of the second stepper motor 700 holds the compartment 500 in first position when the information storage media 512 is slid into the device receiving aperture 900 (FIG. 9). Actuation of the second stepper motor 700 to the first position may facilitate a media acceptance operation wherein the information storage media 512 is accepted into the apparatus 510 by holding the compartment 500 the first or upright position. Actuation of the second stepper motor 700 to the second position may facilitate a media rejection operation wherein the information storage media 512 when it drops to the second or down position wherein gravity causes the information storage media 512 to slide out of the apparatus 510. Coupling these two stepper motor operations together, media can be accepted into the apparatus 510, be held in place by the second stepper motor 700 and be stopped in forward travel by the media accept door 601, be scanned by the scanning device 804 to have barcodes on the information storage media 512 recognized and decoded by the processing device 514, and decide whether to accept or reject the information storage media 512 based on this barcode information or the configuration of the apparatus 510.

In some configurations, the pivot point (e.g., the compartment shaft 504) of the compartment 500 can be adjusted forward towards the front panel 502 of the housing 505, allowing for a shallower design of the apparatus 510 to be created and reducing the stall torque requirements on the second stepper motor 700. When the pivot point (e.g., the compartment shaft 504) is closer to the center of the apparatus 510, the lever arm may be reduced by 50% and the stall torque may be reduced by a similar amount.

In some configurations, a curved piece of metal can be fixed at the end of the compartment 500 wherein the compartment 500 can be actuated to align itself with the device receiving aperture 900 and the flat of the curved metal. The curved metal may provide a stopping plate for the information storage media 512 when the information storage media 512 enters the apparatus 510, such that when the information storage media 512 is accepted, the compartment 500 rotates above the device receiving aperture 900, causing the end of the compartment 500 to fall below the curved metal wherein the information storage media 512 begins sliding through the device receiving aperture 900. If the information storage media 512 is rejected, then the compartment 500 would rotate below the device receiving aperture 900 and the curved metal would provide support for the information storage media 512 along the travel path up to parallel with earth, where it would start to slide towards the media reject opening 901. The curved piece of metal could be either fixed in place within the apparatus 510 or in a sliding slot such that movement of the curved metal is constrained between the device receiving aperture 900 and parallel with the earth positions.

Turning to FIG. 8, the scanning device 804 and the distance sensor 802 of the apparatus 510 are shown coupled to a mount 506. The scanning device 804 may be selected from the group comprising a camera, a 1D scanner, a 2D image sensor, a barcode scanner, and combinations thereof. This distance sensor 806 may be selected from the group comprising an ultrasonic distance sensor, a vertical cavity surface emitting laser, or single photon avalanche diode, or combinations thereof. The mount 506 may position the scanning device 804 and the distance sensor 806 above the compartment 500 with the information storage medium 512.

The distance sensor 806 may be used for focusing the scanning device 804. For example, different models of information storage media may be scanned using the apparatus 510, which have different heights, emissivity, etc. The distance sensor 806 is disposed in close proximity to the scanning device 804. In one approach, the media entry detection is actualized by continuously polling the distance sensor 806 and when the distance from the distance sensor 806 to the nearest object rises above a calibrated threshold, the processing device 514 may determine that the information storage media 512 has been slid into the apparatus 510. In another approach, the distance sensor 806 may be configured to raise an interrupt when a threshold distance has been crossed, eliminating the need for polling the distance sensor 806. Once the information storage media 512 is detected in the apparatus, the distance sensor 806 may be used to determine the distance to the top of the information storage media 512. The distance to the top of the information storage media 512 may be communicated to the scanning device 804, which may have an auto-focusing lens. The auto-focusing lens may be adjusted to the focal length that aligns with the distance received from the distance sensor 806. Auto-focusing algorithms of the scanning device 804 may involve image retrieval, computer vision algorithm computations (Sobel filters, image derivatives, Laplacians, etc.), and the movement of a lens aperture. Considering the variability of media heights that may be encountered during operation of the apparatus 510, such algorithms may lead to long focusing times. For example, certain scanners claim a 10-second processing time per drive, which is in line with focusing times of existing vendor provided software libraries.

In some embodiments, the scanning device 804 may be automatically focused using industry standard algorithms, providing a way to improve the quality of scan data without or with limited user intervention. Additionally, in some embodiments, mount 506 may be movable. For example, the mount 506 may be coupled to a turning gantry. The movable mount 506 may the scanning device 804 may be configured to mechanically change the position (e.g., a vertical height) of the scanning device 804 to bring the media within the auto-focusing range. In this manner, the apparatus 510 may accommodate information storage media 512 of different sizes (e.g., different vertical heights).

In some configurations, an interior cavity of housing 505 of the apparatus 510 may include one or more lighting devices to illuminate the internal chamber for scans performed via the scanning device 804. The lighting devices may be operatively coupled to the processing device 514. The lighting devices can be either in the visible spectrum or in a non-visible spectrum, such as infrared, with an appropriate image sensor filter to isolate the wavelength of interest.

In some configurations, in response to the distance sensor 806 determining that the information storage medium 512 has been placed in the compartment 500, the compartment 500 can be rotated, for example about 15 degrees, to prevent or limit further insertion of additional storage media into the compartment while the detected medium is scanned.

In operation, the scanning device 804 may scan the information storage medium 512 to obtain information, such as barcodes, disposed thereon. The processing device 514 may be configured to determine whether to accept or reject the information storage medium 512 based at least in part upon the information received from the information storage medium 512. If the medium is accepted, i.e., the scan identifies the information storage medium 512 and the processing device 514 determines that the identified information storage medium 512 is listed as one to be processed, a door, such as the media reject door 603, may be opened to allow the information storage medium 512 to transfer into a further device. For example, the information storage medium 512 may be transferred to downstream device to be degaussed and/or physically destroyed. If the information storage medium cannot be read or is not listed to be further processed, the compartment 500 may be further rotated to slide the information storage medium 512 out of the media reject opening 901.

Turning to FIG. 9, the front panel 502 of the apparatus 510, with the device receiving aperture 900 and the media reject opening 901, is shown. The media reject opening 901 is shown blocked by the media reject door 603. The media accept opening 1004 in the rear panel 516 is also shown. The media reject door 603 is shown blocked by the media accept door 610. As illustrated, a bearing 902 is coupled to the wheel 600 (FIG. 6) to provide smooth movement of the media accept door 610.

Turning to FIG. 10, the compartment 500 is shown in the second or lowered position to allow the information storage medium 512 to translate out of the apparatus 510 via the media reject opening 901. As shown, the apparatus 510 includes a reject position indicator limit switch 1001 to determine when the compartment 500 is in the second position. The reject position indicator limit switch 1001 is disposed to detect or sense the compartment 500 in the second or lowered position.

In some implementations, the apparatus 510 described with reference to FIGS. 5-10 is configured as a desktop unit where the scanning device 804 is suspending above an open-air volume for manual scanning, which may reduce the mechanical complexity of the apparatus 510. In such a configuration, the apparatus 510 may lack a housing 505 or portions thereof. A user may manually slide or pass the media past the scanning device to perform a scan. The open-air configuration may enable use of the apparatus 510 to be used in conjunction with downstream degausser devices for erasure of the scanned media and/or destruction devices for destruction of the scanned media. For example, the open air-configuration may be used in conjunction with degaussers and/or destruction devices that are manually loaded with media for destruction. The downstream degausser and/or destruction devices may be electrically coupled to the processing device 514 of the apparatus 510 such that degauss and destroy confirmation can be logged and tracked for the scanned media.

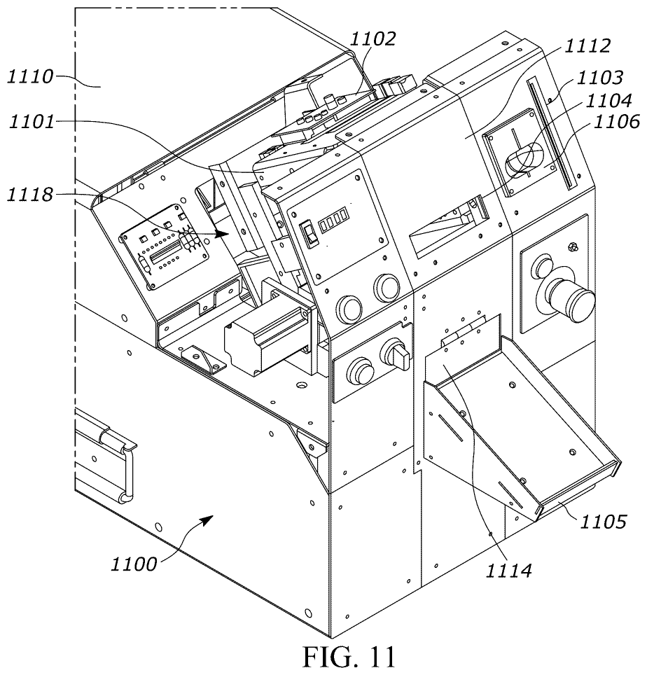

The apparatus 510 may achieve fast processing times, in part, due to use of the distance sensor 806. For example, with use of the distance sensor 806 subsequent media that enter the apparatus 510 of a similar height may experience faster processing time. In some aspects, the processing time may be below three seconds, making the apparatus 510 compatible in processing speed with certain degaussers, such as permanent magnet degaussers. Thus, achieving quick processing times may enable the apparatus 510 to be mounted to or otherwise coupled with a degausser such as in the example illustrated in FIGS. 11-13.

Turning to FIGS. 11-13, an apparatus 1100 that may be used for processing secure media at a secured facility, according to some embodiments. The apparatus 1100 is a degausser 1110, such as a permanent magnet degausser, that is operable to generate strong, controlled magnetic field to erase data from a magnetic storage media. The apparatus 1100 may be generally the same as the apparatus 510 described with reference to FIGS. 5-10, with a difference being that the media accept opening of the device releases the media being processed to the downstream degausser 1110 for erasure. The apparatus 1100 may be further coupled to another downstream process, for example, at the outlet of the degausser 1110. For example, a counter may be disposed at an outlet of the degausser 1110 to provide verification that media processed by the apparatus 1100 has been degaussed. In another example, a destruction device may be disposed at the outlet of the degausser 1110 to destroy media processed by the apparatus 1100 and providing a destruction time stamp for the media.

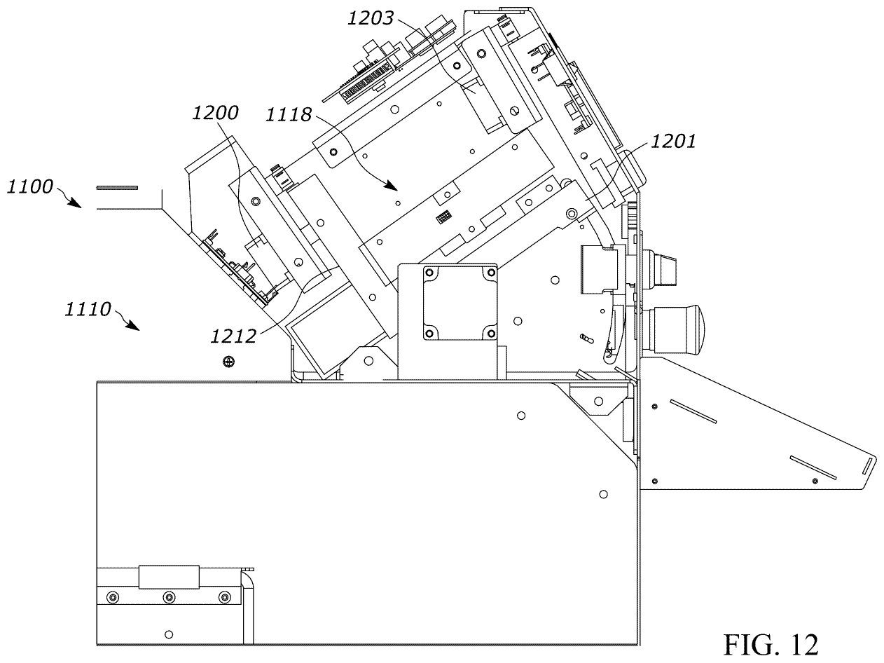

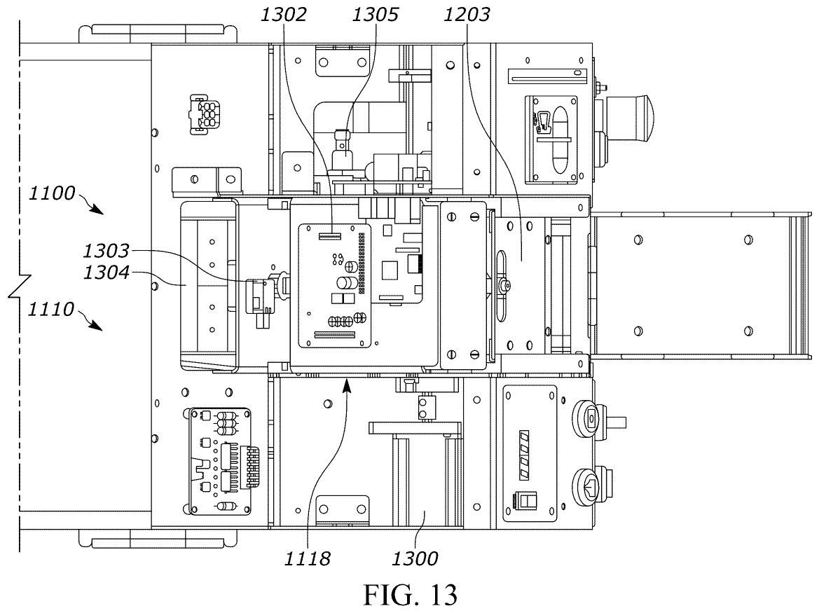

The apparatus 1100 generally includes a scanner 1118 that is similar to the apparatus 510 described with reference to FIGS. 5-10. The scanner 1118 may scan media to obtain information disposed thereon, such as barcodes disposed on the media or other serialization information. The scanner 1118 is disposed upstream of the degausser 1110. The scanner 1118 includes a scanning device (not shown) and, in some aspects, a position sensor (not shown) coupled to a mount 1302 (FIG. 13). The scanning device may be the same as the scanning device 804 used in the apparatus 510 and the position sensor may be the same as the position sensor 805 used in the apparatus 510. In some configurations, the apparatus 1100 includes a plurality of distance sensors positioned along the length of a media accept door 1212 (FIG. 12). The plurality of distance sensor may divide a scanning chamber of the scanner 1118 separate regions. In this manner, if a medium, such as a 3.5-inch hard drive, is inserted into the machine, then each of the distance sensors may indicate that media is present. If a smaller medium, such as a 2.5-inch hard drive is inserted into the apparatus 1100, then only some of distance sensors may indicate that media is present. Use of a plurality of distance sensors in this manner may improve detection of small media, and also improve the focusing algorithm for the scanning device by specifically focusing in the region where media is present, as opposed to the default region which is the center portion of the media, which may reduce or minimize distortions caused by a default focusing region.

The apparatus 1100 includes a housing 1101 that may include one or more lights for illuminating the media being scanned by the scanning device. In some configurations the apparatus 1100 is enclosed, for example, by a housing allowing the chain of custody to be unbroken when processing the media, for example, the chain of custody may be unbroken between a scanning operation performed by the scanner 1118 and a degaussing operation performed by the degausser 1110.

Turning to FIG. 11, the apparatus 1100 includes a front panel 1112 defining a device receiving aperture 1104 for receiving media for scanning and erasure and the media reject opening 1114 for releasing media rejected during the scanning operation. A slide 1105 is coupled to the media reject opening 1114 for guiding media rejected and released during operation of the apparatus 1100. The front panel 1112 further defines a transfer device 1103, which is a media drive in the illustrate embodiment and is referred to herein as media drive 1103. The media drive 1103 which is a port for inserting transfer storage media such that information read from media scanned using the apparatus 1100 can be exported to the transfer storage medium. In some implementations, the transfer storage medium is a digital storage medium such as a DVD, a CD-ROM, an SD card, a solid state drive, or a hard disk drive. In alternative implementations, the media drive 1103 may be replaced by or further include a printer that prints machine-readable code embedding information acquired by scanning media via the scanner 1118. In such an implementation, the transfer storage medium may be a piece of paper that embeds the information in machine-readable code.

In some implementations, information exported to or embedded on the transfer storage media (e.g., a DVD, flash media, a piece of paper printed by a printer, etc.) may provide degausser information, such as user inputs or degaussing settings, associated with the degausser 1110 in addition to serialization information that tracks the media being processed. In one example, the apparatus 1100 scans a barcode on a media inserted into the apparatus 1100 to identify the media and the acquires degausser settings for a degaussing operation that is used to erase the media and associates the degausser settings with the media identifier.

Still referring to FIG. 11, the front panel 1112 includes a card scanner 1106 configured to obtain user identification information from a card associated with a user. The card scanner 1106 may be a smart card reader that is operable to read a Common Access Card (CAC) or another smart card that identifies the user.

In some implementations, the front panel 1112 may include a degausser interface that includes one or more displays, buttons, switches, panels, etc. though which a user may receive information on and/or input information to the degausser 1110, such as information related to degausser settings for a degaussing operation.

In some aspects, the apparatus 1100 is fully enclosed and mounted to an entry port of the degausser 1110 such that a user is unable to grab a piece of media from the apparatus 1100 before it is accepted and processed by the apparatus 1100 or rejected and released back to the user. When a user inserts a piece of media, the media is either accepted and transferred to the degausser 1110 or rejected and released via the media reject opening 1114. In operation, a user scans a card using the card scanner 1106 to initiate operation of the apparatus 1100. Once the piece of media is inserted into the machine, the piece of media is in an enclosed environment for scanning and degaussing and the enclosed environment may prevent the user from removed the media from the apparatus 1100 and the apparatus 1100 may determine whether the media is accepted or rejected.

Turning to FIG. 12, the apparatus 1100 includes a compartment 1201 for receiving media. In FIG. 12, the compartment 1201 is shown in the first or upright position for scanning media via the scanner 1118. The compartment 1201 may be the same as the compartment 500 of the apparatus 510 that is described with reference to FIGS. 5-10. The compartment 500 may receive media, such as information storage media, from the device receiving aperture 1104. As shown in FIG. 12, the apparatus 1100 includes an entry door 1203 that is configured to block the device receiving aperture 1104 to prevent the entrance of media into the apparatus 1100.

Still referring to FIG. 12, the apparatus 1100 further includes a media accept door 1212 disposed adjacent to control the release of media from the scanner 1118 to the degausser 1110. The media accept door 1212 may movable between a closed configuration and an open configuration. In the closed configuration, the media accept door 1212 may prevent the entrance of media to the degausser 1110. In the open configuration, the media accept door 1212 may permit media to move from the scanner 1118 to the degausser 1110 for a degaussing operation. In some implementations, the media accept door 1212 the same as the media accept door 601 of the apparatus 510.

Turning to FIG. 13, the apparatus 1100 further includes a belt 1304 to translate media through the degausser 1110 and an inductive sensor 1305 operable to sense the position of cleats on the belt 1304 of the degausser 1110. In some implementations, the inductive sensor 1305 is operable to detect movement of the cleats. By timing cleat movement, the media being processed by the apparatus 1100 can be reliability released into the media cavity of the degausser 1110 on the belt 1304.

FIG. 13 further illustrates a limit switch 1303 configured to indicate a position of the media accept door 1212 (FIG. 12) of the apparatus 1100. The limit switch 1303 may sense and provide an indication of whether the media accept door 1212 (FIG. 12) is in the closed position or the open position.

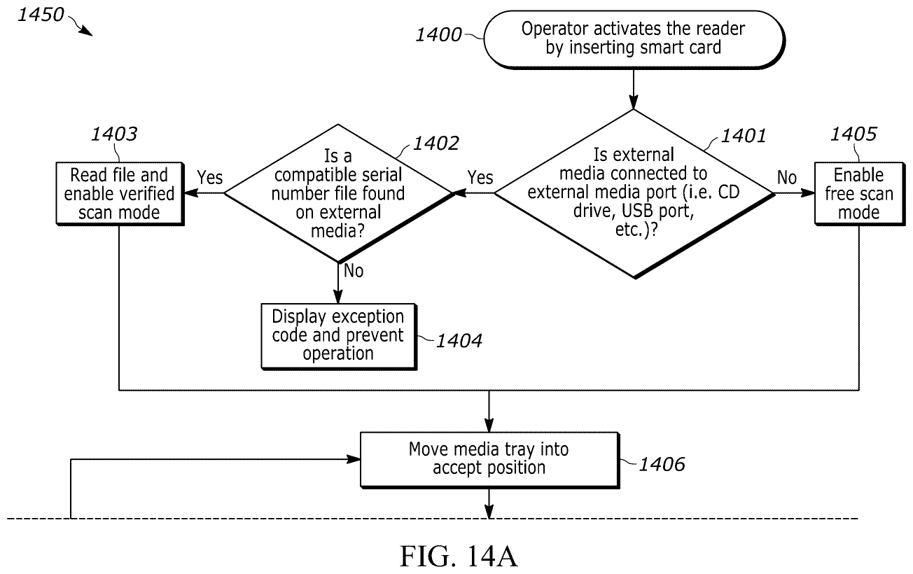

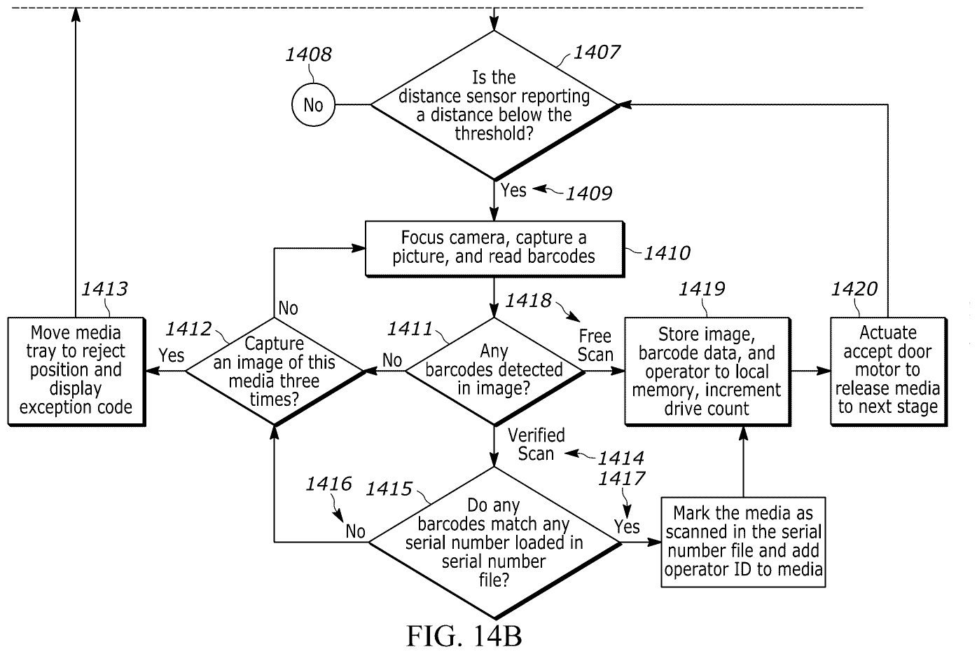

Turning to FIGS. 14A and 14B, a method 1450 of operating an apparatus, such as the apparatus 510 or the apparatus 1100, to process information storage media is shown. The method 1450 or portions thereof may be performed via a processing device associated with the apparatus, such as the processing device 514 of the apparatus 510.

At 1400, an operator activates a card reader by inserting a smart card. An electrical system of the apparatus then communicates with the card reader and retrieves a unique identifier (ID) programmed into the smart card. A processing device of the apparatus may then associate or use the unique ID for actions taken by the apparatus.

At 1401, the processing device determines if external storage media (e.g., the external transfer medium), such as a CD-ROM, flash drive, etc., are connected to the machine via a media drive. Upon determining that external storage media is present (e.g., coupled to the apparatus via the media drive), at 1402, the processing device searches for a compatible serial number file that may be used to identify the media entered into the apparatus. If a compatible serial number file is present, at 1403, the processing device may read the file and store the file in local memory during a use section. If a compatible serial number file is not present, at 1404, the processing device may raise an error and prevent operation of the apparatus and prompt the user to restart the process. Upon determining that no external storage media is present (e.g., coupled to the apparatus via the media drive), at 1405, the processing device may enable a free scan mode.

At 1406, the processing device causes coupled actuators (e.g., the stepper motors) to configure the apparatus to be in a media accept position, such as the first or upright position, described with reference to the apparatus 510. In the media accept position, the compartment may be positioned and, in some aspects, locked, in the first or upright position with the media accept door closed.

At 1407, the processing device monitors the distance sensor(s) to determine if media has been entered the apparatus. At 1408, upon determining that the distance received from the distance sensor(s) is above a threshold distance, the processing device may do nothing. When the apparatus is empty (e.g., has not received media for processing), the sensed distance reported from the distance sensor to the processing device may be the distance from the distance sensor to the compartment surface directly below the distance sensor. When the media has entered into the apparatus, the sensed distance reported from the distance sensor to the processing device may be the distance from the distance sensor to the top surface of the media directly below the sensor. The processing device may use a threshold to distinguish between when the sensed distance is between the compartment versus the top of the media in the compartment.

At 1409, the processing device determines that the distance value measured by the distance sensor has crossed the threshold value. At 1410, the processing device may focus the scanning device (e.g., a camera), for example, using an autofocus algorithm that is based at least in part up on the measured distance value. Once the scanning device is focused, the processing device may capture a scan and process the scan data. When the scanning device is a camera, the scan data may be an image (e.g., a full resolution image) and the processing device may process the image, for example, using software libraries and/or by decoding machine-readable code (such as a barcode) present in the image.

At 1411, the processing device may process the scan data (e.g., an image) to determine whether machine-readable code, such as one or more barcodes, are present in the scan data. In some aspects, upon determining that no barcodes are present in the scan data, the processing device may cause additional scans of the media to be performed via the scanning device. For example, at 1414, the processing device may determine whether a plurality of scans of the media (e.g., a predetermined number such as 2, 3, 4, etc.) have been performed. Upon determining that the predetermined number of scans have not been performed, the processing device may repeat blocks 1410-1411 until reaching the predetermined number of scans. Upon determining that the predetermined number of scans have been performed, the processing device may actuate the compartment of the apparatus to the second or lowered position (e.g., the reject position) and, in some approaches, cause a user interface of the apparatus to display an indication of a bad read.

At 1414, upon determining that machine-readable code (e.g., barcodes) were detected in the scan data, the processing device may place the apparatus in a verified scan mode. At 1415, the processing device determines whether the machine-readable code (e.g., barcodes) matches machine-readable code in the compatible serial number file. Upon determining that the machine-readable code does not match code in the compatible serial number file, at 1416, the processing device may reprocess the media. Upon determining that the machine-readable code matches code in the compatible serial number file, at 1417, the processing device may mark the media as scanned in the compatible serial number file. At 1418, the processing device places the apparatus in free scan mode. At 1419, the apparatus is in free scan mode or has had a successful read of machine-readable code (e.g., a serial number) on the media and the processing device stores the scan data, the machine-readable code, and a unique ID associated with the operator to local memory and may increment the number of media being stored in local memory. At 1420, the processing device may actuate the media accept door, releasing the media to downstream equipment. The apparatus may then repeat the method 1450.

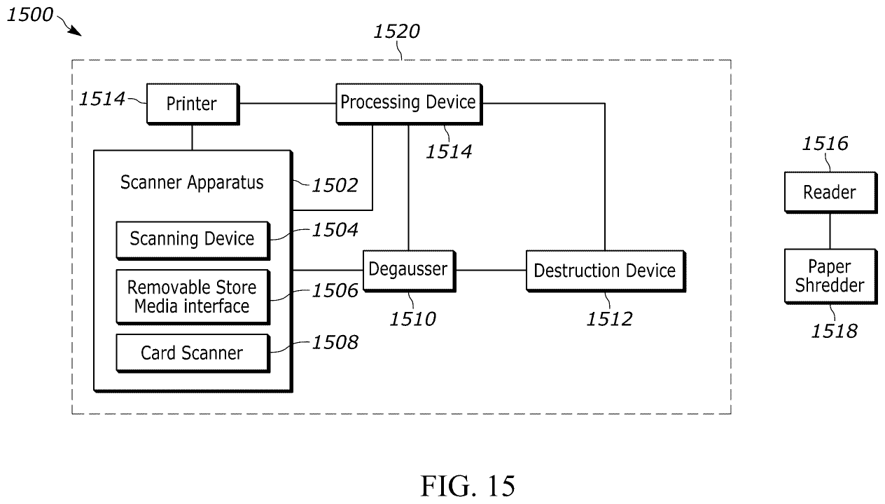

FIG. 15 illustrates a system 1500 that incorporates one or more of the apparatuses described herein. The system 1500 includes a scanner apparatus 1502 to perform a scanning operation to acquire and track serialization information associated with media, a degausser 1510 to perform a degaussing operation to erase of the media, and a destruction device 1512 to perform a destruction operation to destroy the media. The scanner apparatus 1502, the degausser 1510, and the destruction device 1512 are operatively connected to a processing device 1514 that may be configured to control one or more the scanning operation, the degaussing operation, and the destruction operation and to receive and track data associated with such operations.

In some implementations, the scanner apparatus 1502, the degausser 1510, the destruction device 1512, and the processing device 1514 are housed in a secure facility 1520, such as an SCIF. A user may perform one or more of the document operation, the degaussing operation, and the destroy operation on information storage media within the secure facility 1520 and print machine-readable code embedding information on such operations and serialization information on the information storage media processed via the printer 1513. The user may take the printed material (e.g., a printed paper) with the machine-readable code and exit the secure facility 1520 (e.g., the SCIF). Outside of the secure facility, the reader 1516 can be used to read the printed material with the machine-readable code and, in some aspects, the paper shredder 1518 can be used to destroy the printed material.

The scanner apparatus 1502 includes a scanning device 1504, a removable storage media interface 1506 for the exchange of data between the processing device 1514 and external storage media, and a card scanner 1508 for acquiring information, such as identifier (e.g., a smart card ID) associated with an operator of the system 1500. The scanning device 1504 includes or is coupled to a printer 1513 for printing machine-readable code that embeds information from the scanning operation, such as serialization information on the media processed by the system 1500. The scanner apparatus 1502 may be any of the apparatuses described herein. In some examples, the scanner apparatus 1502 is and/or includes the apparatus 110 described with reference to FIG. 1. In some examples, the scanner apparatus 1502 is and/or includes the apparatus 510 described with reference to FIGS. 5-10. In some examples, the scanner apparatus 1502 is the apparatus 1100 described with reference to FIGS. 11-13 such that the scanner apparatus 1502 is integrated with the degausser 1510.

The scanner apparatus 1502 may optionally be integrated with downstream equipment such as the degausser 1510 and/or the destruction device 1512. In some implementations, the system 1500 is configured to perform a document, degauss, and/or destroy process including a document operation, a degauss operation, and a destroy operation. In the document operation, the scanner apparatus 1502 may scan one more information storage media to read information, such as serialization information (e.g., barcodes), from the information storage media, embed such information in machine-readable code, and print the machine-readable code via the printer 1513. In some examples, the method 1450 is used to perform the document operation or portions thereof. The processing device 1514 may send a signal to downstream equipment, such as the degausser 1510 and/or the destruction device 1512, causing the downstream equipment to begin processing media, including to perform the degaussing operation and/or the destroy operation. In some aspects, the processing device 1514 may determine. In some examples, the processing device 1514 may cause downstream equipment to perform the degaussing operation and/or the destroy operation for information storage media that have been approved in the document operation (e.g., have been approved for processing) and will not operate downstream equipment for information storage media that have been rejected in the document operation. In the case of media being rejected, the downstream equipment will not operate, conserving energy and lengthening time between service appointments.

The scanner apparatus 1502 may optionally include the removable storage media interface 1506. The removable storage media interface 1506 may enable data to be input to the data processing device 1514 via one or more storage media, such as flash drive or CD-ROM to provide data import functionality. For example, the storage media may be inserted into or coupled with the removable storage media interface 1506 to provide a way for the operator to define which barcodes define the serialization information of the information storage media to be processed (e.g., using a standardized file format, such as a spreadsheet). Providing data on the information storage media to be proceed may provide the added benefit of verifying that the information storage media is intended to be decommissioned and may also provide an archival picture of the information storage media. In some examples, the processing device 1514 may update the data on the file, providing verification that the scan (e.g., the document operation) occurred and the date and time of occurrence. In the case of the entire facility being a SCIF, such a file update may enable the decommissioning process to be fully integrated into the system 1500.

The reader 1516 may be any device that is operable to read the machine-readable code that is embedded on paper (or another storage medium) via the printer 1513. In some examples, the reader 1516 is the reader 220 that is described with reference to FIG. 2. The system 1500 may be used to exfiltrate information on the media processed (e.g., serialization information including the barcode data from the media processed) from the secure facility 1520. In some embodiments, the scanner apparatus 1502 includes or is coupled with the printer 1513 to print machine-readable code embedding information on the media processed and used in conjunction with the reader outside of the secure facility 1520 to read in the machine-readable code.

In some embodiments, the exit slot of the reader 1516 is interfaced to a paper shredder 1518 for destruction of the paper with the machine-readable code. In some embodiments, the reader 1516 may have an export function, whereby a storage medium such as a non-volatile storage medium (e.g., a flash drive or CD-ROM), may be placed within a port of the reader 1516, allowing the aggregated serialization information embedded in the machine-readable code to be written to the storage medium for processing at a different time and/or in a different physical location.

In some aspects, a user of the system 1500 may have an existing list of media to be processed during a use session, which may be accessible to the processing device 1514. Access may be effectuated by coupling the removable storage media interface 1506, including, but not limited to, a CD-ROM drive or USB ports for flash drives. When removable storage media are inserted into the scanner apparatus 1502, the list of media to be processed may be retrieved and queried for relevant barcodes when scanning media. Each identification of relevant barcode during the document operation (e.g., while scanning media via the scanner apparatus 1502) may cause an instance of the barcode to be marked on the list and the smart card ID associated with the event may be logged. At the end of the session, the user can export the marked list (including, for example, degaussing details such as the amount of time a medium is exposed to a degaussing magnetic field, a strength of the magnetic field applied to the medium, a day and time of the exposure, a day and time that the medium is physically destroyed, and combinations thereof) back onto the removable storage media to be used in downstream processes for media management and verification. In some aspects, the list may be accessible via a wireless network. For example, the list may be accessible through appropriately designed Representational State Transfer Application Programming Interfaces (REST APIs) that use the smart card ID to retrieve the currently assigned list of media to be processed. In some aspects, the system 1500 may have one or more user interfaces that allow media to be entered into a database using the system 1500, assigned to a rack for use, assigned for destruction after end of life, transferred to a decommissioning service provider, and/or certified as destroyed.

In some implementations, the scanner apparatus 1502 detects and reads one or more machine-readable codes (e.g., barcodes) on the information storage medium that is scanned to obtain a medium identifier that uniquely identifies the information storage medium. The scanner apparatus 1502 may receive a list of identifiers that identifies information storage media that are scheduled to be processed (e.g., scanned, degaussed, and/or destroyed) and compares the list to the medium identifier to determine whether the information storage medium is scheduled to be processed. In some examples, the scanner apparatus 1502 may control one or more actuators of the scanner apparatus 1502 in response to determining that the information storage medium is not scheduled to be processed.

In some implementations, the system 1500 or components thereof may be an Internet of Things (IoT) asset. Information associated with the system 1500 by hosting its information on a cloud service provider. In such an embodiment, a scan database associated with the system 1500 may be housed in the cloud. The scan database may include information associated with the document operation, degauss operation, and/or the destroy operation associated with the information storage media processed by the system 1500. In some examples, the scan databased may include one or more of a model identifier (ID), a manufacturer, a serial number, a date an operation was performed by the system 1500, a user ID, and parameters associated with the operation performed by the system 1500. Cloud storage may allow over the air updates, diagnostic information reporting for preventative maintenance, the transmission of lists of media information (serial number, model number, etc.) to the system 1500, and/or the transmission of information (lists, etc.) from the system 1500.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept. For instance, the illustrated methods may omit any individual step and any illustrated embodiment may positively omit any unillustrated element.

1. An apparatus for processing secure media at a secured facility, the apparatus comprising:
a housing defining a device receiving aperture;
a card scanner configured to obtain user identification information from a card associated with a user;
a compartment disposed within the housing to receive an information storage medium;
a scanning device disposed and configured to capture device information from the information storage medium;
a transfer device; and
a processing device operatively connected to the card scanner and the scanning device to associate the user identification information with the device information and to control the transfer device to embed machine-readable code including the user identification information and status information derived from the device information on a transfer storage medium.

2. The apparatus of claim 1, further comprising:
a motor connected to move the compartment between a first position to receive the information storage medium that passes through the device receiving aperture and a second position to move the information storage medium out of the apparatus.

3. The apparatus of claim further comprising:
a door motor connected to move a door between open and closed positions respectively opening and closing the device receiving aperture.

4. The apparatus of any of claim 2, wherein the scanning device is from the group comprising: a camera, a 1D scanner, a 2D image sensor, a barcode scanner, and combinations thereof.

5. The apparatus of any of claim 2, further comprising a magnetic degausser disposed to receive the information storage medium from the compartment and configured to degauss the information storage medium.

6. The apparatus of claim 5, wherein the motor is connected to move the compartment to a third position that passes the information storage medium to the magnetic degausser.

7. The apparatus of any of claim 5, further comprising a device shredder disposed to receive and physically destroy the information storage medium.

8. The apparatus of claim 7, wherein the motor is connected to move the compartment to a third position that passes the information storage medium to the device shredder.

9. The apparatus of claim 7, wherein the device shredder is configured to receive the information storage medium from the magnetic degausser.

10. The apparatus of claim 9, wherein the processing device is configured to control the transfer device to embed the machine-readable code to embed the user identification information to associate a user with the information storage medium processed while the card is associated with a processing session.

11. The apparatus of claim 10, wherein the processing device is configured to control the transfer device to embed the machine-readable code to embed the user identification information to associate a user with more than one information storage medium processed while the card is associated with a processing session.

12. The apparatus of claim 11, wherein the processing device is configured to control the transfer device to embed the machine-readable code to embed a timestamp of processing the information storage medium.

13. The apparatus of claim 12, wherein the processing device is configured to control the transfer device to embed the machine-readable code to embed a status of the information storage medium.

14. The apparatus of claim 13, wherein the status includes a degaussing and/or physical destruction status of the information storage medium.

15. The apparatus of claim 14, wherein the processing device is configured to control the transfer device to embed the machine-readable code to embed a status of the information storage medium including one or more of an amount of time the information storage medium was exposed to a degaussing magnetic field, a degaussing magnetic field strength applied to the information storage medium, a date and time at which the information storage medium was degaussed, a date and time at which the information storage medium was physically destroyed, and combinations thereof.

16. The apparatus of claim 2, wherein the processing device is operatively connected to control the scanning device to detect and read one or more machine-readable codes on the information storage medium to obtain a medium identifier that uniquely identifies the information storage medium.

17. The apparatus of claim 16, wherein the processing device is operatively connected to access a list of identifiers that identifies information storage media scheduled to be processed and compare the list to the medium identifier to determine whether the information storage medium is scheduled to be processed.

18. The apparatus of claim 17, wherein the processing device is operatively connected to control the motor to move to the second position in response to determining that the information storage medium is not scheduled to be processed.

19. The apparatus of claim 17, further comprising a network connection configured to allow access to the list from a separate connected device.

20. The apparatus of claim 17, further comprising a drive reading device configured to connect to a storage device and access the list from the storage device.

21. (canceled)
